(19) United States
(12) Patent Application Publication
(10) Pub. No.: US 2022/0296937 A1
(43) Pub. Date: Sep. 22, 2022

(54) ELECTRONIC MASK WITH NEGATIVE PRESSURE

(71) Applicant: INGENIO TECHNOLOGY CO., LIMITED, Chai Wan (HK)

(72) Inventor: Man Yin Arthur Newton CHU, Chai Wan (HK)

(21) Appl. No.: 17/203,305

(22) Filed: Mar. 16, 2021

(51) Int. Cl. A62B 18/00; A62B 7/10; A62B 23/02; A62B 18/08; A62B 9/00

(52) U.S. Cl. CPC A62B 18/006; A62B 7/10; A62B 23/02; A62B 18/08; A62B 9/00

(57) ABSTRACT

An electronic mask with negative pressure includes a mask body, the mask body is provided with a negative pressure cavity, the negative pressure cavity covers mouth and nose, and at least one fan for forming negative pressure in the negative pressure cavity is provided, the power plug of the fan is connected to a control circuit, a first filter device is set to cover the fan; when the fan starts, the air is filtered and evacuated to outside. During the exhaust process, the water vapor in the negative pressure cavity is also discharged, which can effectively reduce the humidity in the negative pressure cavity to ease dyspnea of patients with respiratory diseases and will not increase the burden of breathing. The negative pressure design makes the air exhaled by the human body must be filtered before being discharged without leaking through the gaps of the mask. If the patient wears the mask, it can effectively prevent the spread of viruses or bacteria.

### FIELD OF THE INVENTION

The invention involves a mask, in particular an electronic mask with negative pressure that uses a fan to evacuate and filter exhaled air.

### BACKGROUND OF THE INVENTION

Masks are commonly used as protective equipment, mainly for the protection of respiratory diseases. At present, the most common mask design is multi-layer filtering surgical mask by ear-hanging. The structure is simple and it is generally for one-time use. This type of mask filters both inhaled and exhaled air. But due to its poor sealing, the air may enter and exit through the gap. Another type of mask with good airtightness is similar to the structure of a gas mask. It is generally a normal pressure or pressurized mask, that is, a fan is used to inhale outside air into the mask for breathing. Because humidity and the temperature of the exhaled air are high, the normal pressure or pressurized masks leads to poor comfort in use. It may even cause dyspnea. When patients already have respiratory diseases, using this type of mask may not be conducive to the condition. Further, for the above surgical masks, normal pressure or pressurized masks, the original purpose or use requirements are aimed at ordinary people, not for patient, the above masks are suitable during an outbreak of respiratory disease. But in normal period, normal people wear masks less often, but to prevent the spread of viruses or bacteria, patients need to wear masks. Due to the poor sealing of surgical masks, the air exhaled by the patient may cause infection of the surrounding personnel, while the normal pressure or pressurized mask will increase the burden of the patient's breathing and affect the condition. And there is no specific mask for patients use on the market currently.

### SUMMARY OF THE INVENTION

In view of the aforesaid drawbacks of the prior art, the present invention provides an electronic mask with negative pressure, which forms negative pressure in the mask to inhale air and filter the air exhaled by fan.

The electronic mask with negative pressure includes a mask body, the mask body is provided with a negative pressure cavity, the negative pressure cavity covers mouth and nose, and at least one fan for forming negative pressure in the negative pressure cavity is provided, the power plug of the fan is connected to a control circuit, a first filter device is set to cover the fan; when the fan starts, the air in the negative pressure cavity is evacuated and filtered by the first filter device to set up negative pressure in the negative pressure cavity, the air outside enter into the mask for breathing through the gap in the negative pressure cavity or the gap between the negative pressure cavity and the face.

Further, the first filter device is a first filter, the first filter covers the exhaust vent of the fan, and a cover is provided outside the first filter and is detachably buckled and installed on a base, the edge of the base is detachably installed at the exhaust vent and clamps to fix the edge of the first filter, the cover shields the first filter, and a ventilation gap is provided between the edge of the cover and the inner surface of the seat.

Further, the inner side of the cover is provided with connection poles, the base is provided with connection holes, and the connection poles and the connection holes cooperate for installation; the base is also provided with a support frame to support the cover.

Further, the negative pressure cavity is provided with at least two fans and at least one of the fans is an exhaust fan, the other fans are intake fans; the exhaust volume of the all the exhaust fans is greater than the intake volume of all the intake fans.

Further, the mask body is provided with a mounting hole for installation of the fan, and the fan is buckled into the mounting hole by a mounting base.

Further, the mounting bases are fixed by a connecting bracket, and the mask body is provided with a groove for embedding the connecting bracket.

Further, the edge of the negative pressure cavity fits and seals with the face; it is provided with an air inlet, and a second filter device is buckled at the air inlet, which includes at least a second filter sheet and a filter holder for installing the second filter; the filter holder is provided with an air inlet cavity, and an air inlet is arranged outside the air inlet cavity, the inside of the air inlet cavity is provided with an opening which is covered by the second filter sheet.

Further, the second filter device is replaced with a transparent visual mask.

Further, the control circuit includes a battery compartment and a speed regulating circuit, the battery compartment is connected to the speed regulating circuit, and the output port of the speed regulating circuit is connected to the power plug of the fan.

Further, the edge of the negative pressure cavity (2) is wrapped with a soft pad.

The invention has the following advantages: the fan filters the air and evacuates to outside. During the exhaust process, the water vapor in the negative pressure cavity is also discharged, which can effectively reduce the humidity in the negative pressure cavity to ease dyspnea of patients with respiratory diseases and will not increase the burden of breathing. The negative pressure design makes the air exhaled by the human body must be filtered before being discharged without leaking through the gaps of the mask. If the patient wears the mask, it can effectively prevent the spread of viruses or bacteria.

### BRIEF DESCRIPTION OF THE DRAWINGS

Below are explanations of the invention combining with drawings.

FIG. 1 is front view of the present invention.

FIG. 2 is A-A section view of FIG. 1.

FIG. 3 is perspective view of the present invention.

In the figures: 1. mask body, 2. negative pressure cavity, 3. fan, 4. control circuit, 5. first filter, 6. Cover, 7. base, 8. ventilation gap, 9. support frame, 10. mounting hole, 11. mounting base, 12. connecting bracket, 13. Groove, 14. air inlet, 15. second filter, 16. filter holder, 17. air inlet cavity.

### DESCRIPTION OF THE EMBODIMENTS

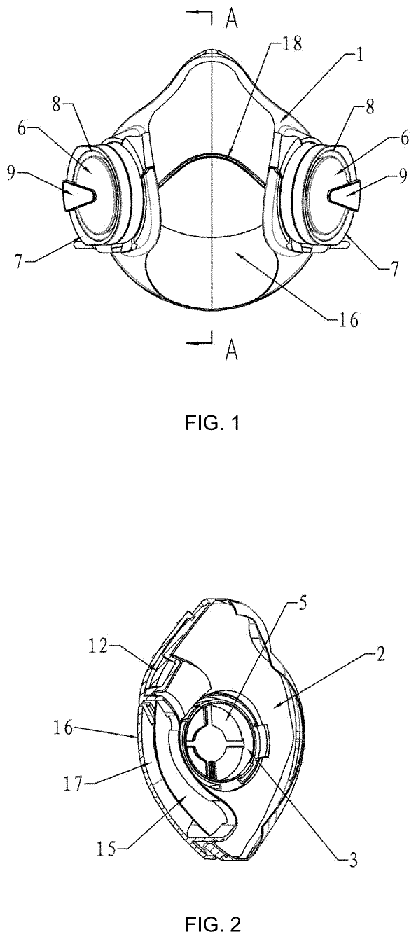

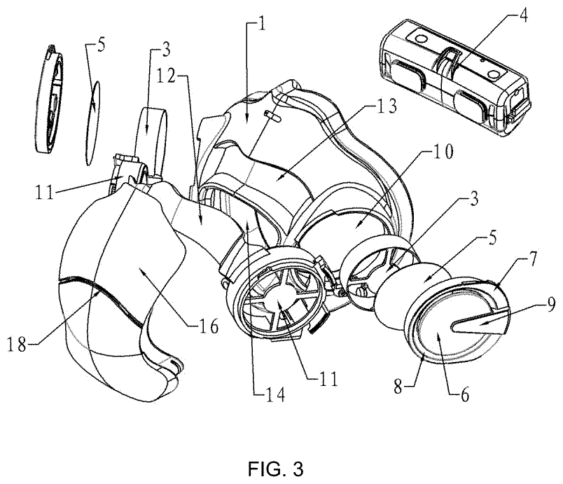

Refer to FIG. 1 to FIG. 3, An electronic mask with negative pressure, whereas includes a mask body 1, the mask body 1 is provided with a negative pressure cavity 2, the negative pressure cavity 2 covers mouth and nose, and at least one fan 3 for forming negative pressure in the negative pressure cavity 2 is provided, the power plug of the fan 3 is connected to a control circuit 4, a first filter device is set to cover the fan; when the fan 3 starts, the air in the negative pressure cavity 2 is evacuated and filtered by the first filter device to set up negative pressure in the negative pressure cavity 2, the air outside enter into the mask for breathing through the gap in the negative pressure cavity 2 or the gap between the negative pressure cavity 2 and the face. The fan 3 filters the air and evacuates to outside. During the exhaust process, the water vapor in the negative pressure cavity 2 is also discharged, which can effectively reduce the humidity in the negative pressure cavity 2 to ease dyspnea of patients with respiratory diseases and will not increase the burden of breathing. The negative pressure design makes the air exhaled by the human body must be filtered before being discharged without leaking through the gaps of the mask. If the patient wears the mask, it can effectively prevent the spread of viruses or bacteria.

The first filter device is the first filter 5, and the first filter 5 can be made of a relatively common filter material on the market, and it is generally required to meet the ASTM Level 1 standard. Cover the first filter 5 at the exhaust vent of the fan 3 to fix the first filter 5 and prevent external pollutants from directly adhering to the outer surface of the first filter 5. The cover 6 is provided on the outside of the first filter 5. The cover 6 is detachably buckled and installed on a base 7, for example, it can be structure such as a screw thread or a buckle, etc. One reason is for installation. Another reason is that it is easy for the disassembly and installation of the first filter 5, specifically, clamping the edge of the first filter 5 to the exhaust vent by the edge of the base 7. In addition, the cover 6 shields the first filter 5 to prevent external contaminants from contaminating the outer surface of the first filter 5. However, in order to maintain ventilation, the ventilation gap 8 sets between the edge of the cover 6 and the inner surface of the base 7.

In order to facilitate the installation of the cover 6 and the base 7, the inner side of the cover 6 is provided with connection poles, the related position of the bas 7 is provided with connection holes to cooperate with the connection poles for installation. Also, the base 7 is also provided with the support frame 9 for supporting the cover 6 to prevent it from falling off by impaction.

According to the situation of use, the negative pressure cavity 2 can set two groups of fans 3 or more. All the fans 3 can be exhaust fans to increase the negative pressure of the negative pressure cavity 2. However, the present invention adopts multiple fans 3 which can change the steering of some fans 3 according to become air intake fans in necessary. Because the air intake gap between the parts in the mask is not enough, when human is in motion or shortness of breath, the oxygen demand will increase, but the air intake cannot be satisfied by the gap of the mask. So part of the fans 3 can be changed to the intake fan in order to ensure the negative pressure of the negative pressure cavity 2 by setting the exhaust volume of the all the exhaust fans is greater than the intake volume of all the intake fans, which can be achieved by controlling the speed of the exhaust fan and the intake fan.

In order to fix the fan 3 conveniently, the cover 1 is provided with a mounting hole 10 for installing the fan 3. The fan 3 is firstly fixed in the mounting base 11, and then the outer wall of the mounting base 11 is provided with barbs, which clamp the edge of the mounting hole 10.

In addition, the connecting bracket 12 is also connected between the mounting base 11, so that multiple fans 3 form a whole and the positions between the fans 3 can also be relatively fixed. It is much more convenient to install the multiple fans 3 to the cover 1. In meanwhile, for the aesthetics of the mask, the cover 1 is provided with the groove 13 for inserting the bracket 12.

According to the situation of use, the mask can also be equipped with the filter device on the intake part to ensure the quality of the air inhaled by the human. So the edge of the negative pressure cavity 2 fits and seals with face and seals the gaps in other parts, then the air inlet 14 is provided to ensure that outside air enters the negative pressure cavity 2 from the air inlet 14 only. The second filter device is buckled at the air inlet 14, which includes at least a second filter 15 and a filter holder 16 for installing the second filter 15; the filter holder 16 is provided with an air inlet cavity 17, and an air inlet 18 is arranged outside the air inlet cavity 17, the inside of the air inlet cavity 17 is provided with an opening which is covered by the second filter 15.

Further, the surgical masks or normal pressure or pressurized masks are opaque. Therefore, after wearing the mask, people cannot observe the expression of user. If permits, a transparent visual mask can be used to replace the second filtering device, so that people can observe the user's expression through the visual mask to facilitate communication. Moreover, the visual mask also adopts a structure similar to the filter holder 16 and is directly buckled at the position of the filter holder 16.

Therefore, in order to ensure that the edge of the negative pressure cavity 2 can fully fit with the human face, for better sealing and comfort of wearing, the edge of the negative pressure chamber is covered with a soft cushion.

In order to control the rotation speed of the fan 3, the control circuit 4 includes a battery compartment and a speed regulating circuit. The battery compartment is connected to the speed regulating circuit. The output port of the speed regulating circuit is connected to the power interface of the fan 3 through the power plug.

1. An electronic mask with negative pressure, whereas includes a mask body, the mask body is provided with a negative pressure cavity, the negative pressure cavity covers mouth and nose, and at least one fan for forming negative pressure in the negative pressure cavity is provided, the power plug of the fan is connected to a control circuit, a first filter device is set to cover the fan; when the fan starts, the air in the negative pressure cavity is evacuated and filtered by the first filter device to set up negative pressure in the negative pressure cavity, the air outside enter into the mask for breathing through the gap in the negative pressure cavity or the gap between the negative pressure cavity and the face.

2. The electronic mask with negative pressure of claim 1, whereas the first filter device is a first filter, the first filter covers the exhaust vent of the fan, and a cover is provided outside the first filter and is detachably buckled and installed on a base, the edge of the base is detachably installed at the exhaust vent and clamps to fix the edge of the first filter, the cover shields the first filter, and a ventilation gap is provided between the edge of the cover and the inner surface of the seat.

3. The electronic mask with negative pressure of claim 2, whereas the inner side of the cover is provided with connection poles, the base is provided with connection holes, and the connection poles and the connection holes cooperate for installation; the base is also provided with a support frame to support the cover.

4. The electronic mask with negative pressure of claim 2, whereas the negative pressure cavity is provided with at least two fans and at least one of the fans is an exhaust fan, the other fans are intake fans; the exhaust volume of the all the exhaust fans is greater than the intake volume of all the intake fans.

5. The electronic mask with negative pressure of claim 1, whereas the mask body is provided with a mounting hole for installation of the fan, and the fan is buckled into the mounting hole by a mounting base.

6. The electronic mask with negative pressure of claim 5, whereas the mounting bases are fixed by a connecting bracket, and the mask body is provided with a groove for embedding the connecting bracket.

7. The electronic mask with negative pressure of claim 1, whereas the edge of the negative pressure cavity fits and seals with the face; it is provided with an air inlet, and a second filter device is buckled at the air inlet, which includes at least a second filter and a filter holder for installing the second filter; the filter holder is provided with an air inlet cavity, and an air inlet is arranged outside the air inlet cavity, the inside of the air inlet cavity is provided with an opening which is covered by the second filter.

8. The electronic mask with negative pressure of claim 7, whereas the second filter device is replaced with a transparent visual mask.

9. The electronic mask with negative pressure of claim 1, whereas the control circuit includes a battery compartment and a speed regulating circuit, the battery compartment is connected to the speed regulating circuit, and the output port of the speed regulating circuit is connected to the power plug of the fan.

10. The electronic mask with negative pressure of claim 7, whereas the edge of the negative pressure cavity is wrapped with a soft pad.
